(19) United States
(12) Patent Application Publication
(10) Pub. No.: US 2004/0203676 A1
(43) Pub. Date: Oct. 14, 2004

(54) Method and system for enabling web content to load on a called party's cellular phone

(75) Inventors: Faisal M. Awada, Round Rock, TX (US); Joe Nathan Brown, Austin, TX (US); Victor Espinoza JR., Pflugerville, TX (US)

Correspondence Address: SAWYER LAW GROUP, P.O. Box 51418, Palo Alto, CA, 94303, US

(73) Assignee: International Business Machines Corporation, Armonk, NY

(21) Appl. No.: 10/125,633

(22) Filed: Apr. 18, 2002

(51) Int. Cl. H04M 3/42

(52) U.S. Cl. 455/416; 455/445; 455/414.1; 455/426.1

(57) ABSTRACT

A method and system for accessing a public network on a party's cellular phone after a call is established between a plurality of parties on a cellular network is disclosed. The method and system comprises providing a command over the cellular network from an initiating cellular phone to at least one of the plurality of the parties cellular phone that causes the at least one party's cellular phone to access a public network. The method and system further includes loading content from the public network to the at least one party's cellular phone based upon the command. The system and method in accordance with the present invention makes it possible for one of the parties on the call to cause the other cellular phones to automatically access the desired web content.

### FIELD OF THE INVENTION

The present invention relates generally to cellular phones and more particularly to a method and system for loading Internet content on a phone.

### BACKGROUND OF THE INVENTION

Cellular phones are utilized extensively for phone calls. As the phone have proliferated new features have been added to increase their utility. One feature that is present on many cellular phones is the ability to access the worldwide web or the Internet. For example, a caller can access the web either before or while a call is established with another party. While a cellular phone call is established between parties it may be necessary or desirable to view the same web content at the same time on each of the cellular phones capable of accessing the Internet. In order to accomplish this at the present time, each party would need to enter the URL address for one or more desired Internet web sites by utilizing each cellular phone's keypad. This is an inefficient and error prone process.

Accordingly, what is desired is a system and method that after a call is established that the calling and called party can automatically access the desired content on the Internet without requiring inputting of the URL using the cellular phone keypad. The system and method should be easy to implement and be cost effective. The present invention addresses such a need.

### SUMMARY OF THE INVENTION

A method and system for accessing a public network on a party's cellular phone after a call is established between a plurality of parties on a cellular network is disclosed. The method and system comprises providing a command over the cellular network from an initiating cellular phone to at least one of the plurality of the parties cellular phone that causes the at least one party's cellular phone to access a public network. The method and system further includes loading content from the public network to the at least one party's cellular phone based upon the command.

The system and method in accordance with the present invention makes it possible for one of the parties on the call to cause the other cellular phones to automatically access the desired web content without the other party having to enter the URL.

### BRIEF DESCRIPTION OF THE DRAWINGS

FIG. 1 is a block diagram illustrating a plurality of cellular telephones which can also interact with a public network such as the Internet.

FIG. 2 is a flowchart illustrating a method by which one party on a multi-party call can load calls to the other parties on the multi-party call in accordance with the present invention.

FIG. 3 is a block diagram of a cellular telephone in accordance with the present invention.

FIG. 4A is a flow chart illustrating providing the URL of a web page from the initiator's cell phone.

FIG. 4B is a flow chart which illustrates receiving the URL by a recipient from the initiator.

FIGS. 5A-5E are diagrams illustrating the telephone displays utilized when loading a web page from one cellular phone to another phone.

### DETAILED DESCRIPTION

The present invention relates generally to cellular phones and more particularly to a method and system for loading Internet content on a phone. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

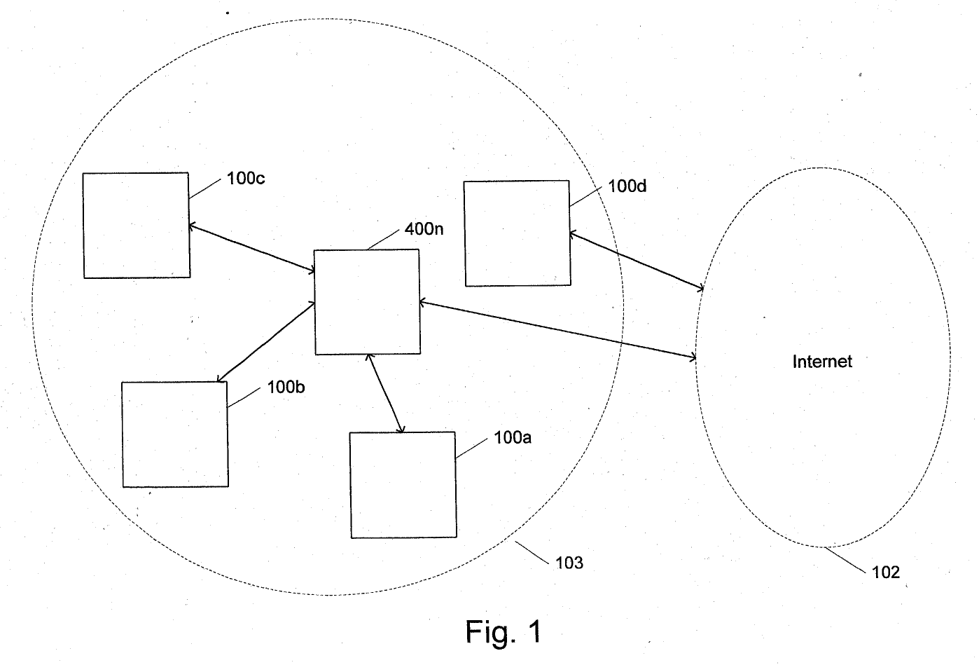

FIG. 1 is a block diagram illustrating a plurality of cellular telephones 100a-100n in a cellular network 103 which can also interact with a public network such as the Internet 102. As is seen, each of the cellular phones 100a-100n are capable of communicating with each other as well as with the Internet.

A method and system in accordance with the present invention allows one of the parties on an established call to cause the other cellular phones to automatically access the desired web content. The automatic download is provided to the other party without requiring the other party to enter the URL. In so doing the web content can be accessed more efficiently and in an error free manner. To describe the features of the present invention in more detail refer now to the following discussion in conjunction with the accompanying figures.

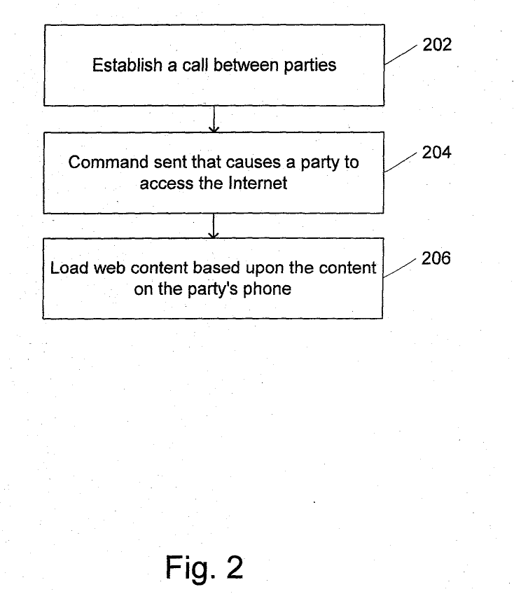

FIG. 2 is a flowchart illustrating a method by which one party on a multi-party call can load calls to the other parties on the multi-party call in accordance with the present invention. First, a call is established between at least two parties, via step 202. Next, one of the parties (the initiating party) sends a command via the call that causes the other party's phone to access the Internet, via step 204. Thereafter, the web content based upon the command is loaded into the other party's phone, via step 206.

Once the initiator has sent the command and all cellular phones have loaded the web page specified by the URL, the parties can then use the displayed web content in the manner intended by the initiator. The URL content could consist of sales data, a schematic, a photograph, a map, etc.

One of the key features of the present invention is a cellular phone that provides encoded commands for delivery of the URL and that can decode the commands to download the web content. The features of the phone are described below.

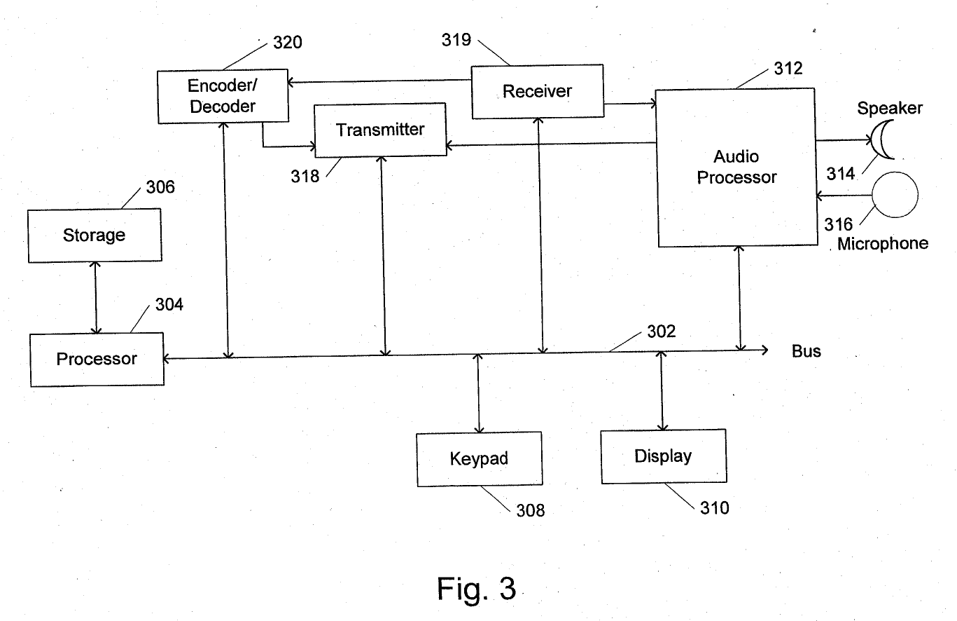

FIG. 3 is a block diagram of a cellular telephone 100 in accordance with the present invention. The cellular phone 100 includes a bus 302. A processor 304 is coupled to the bus 302. A storage medium 306 is coupled to the processor 304. A telephone keypad 308 and display 310 are coupled to the bus 302. An audio processor 312 also is coupled to the bus 302.

The audio processor 312 receives signals from a microphone 314 and transmits signals to a speaker 316. The audio processor receives signals from a receiver 319. The transmitter 318 and the receiver 319 are also coupled to the bus 302. The receiver 319 provides signals to an encoder/decoder 320 and the transmitter 318 receives signals from the encoder/decoder 320. The encoder/decoder 320 is coupled to the bus 302. The encoder/decoder 320 encodes the URL from either the storage medium 306 or the URL from a page currently displayed and decodes the command received from a cellular phone which initiates a loading of a web page.

The cellular phone 100 also has the ability to send a command over the cellular network that will cause the recipient's phone to access the Internet for a URL that is encoded in the command. The encoder/decoder 320 receives and executes the command using the web page specified by the URL. The storage medium 306 stores URLs in the cellular phone. The telephone keypad 308 initiates commands from the cellular phone using the URL of a web page currently displayed on the phone and also has the ability to select the stored URLs and initiate the transmission of the encoded command. Although a keypad is utilized as the user interface (UI) in this embodiment, the UI could be a variety of devices such as a mouse or a stylus. The UI could, for example, also be a voice recognition system.

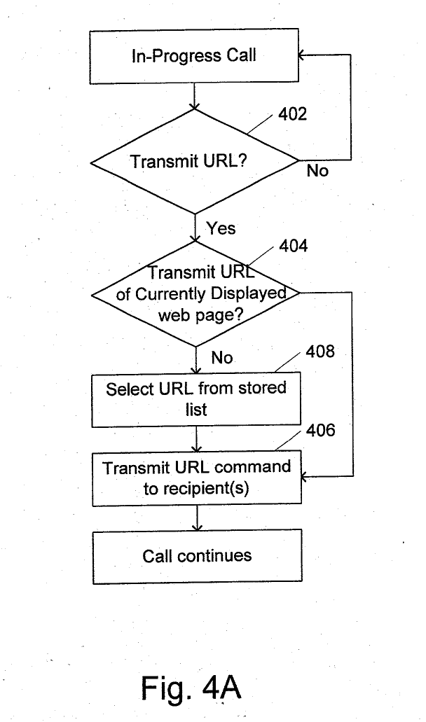

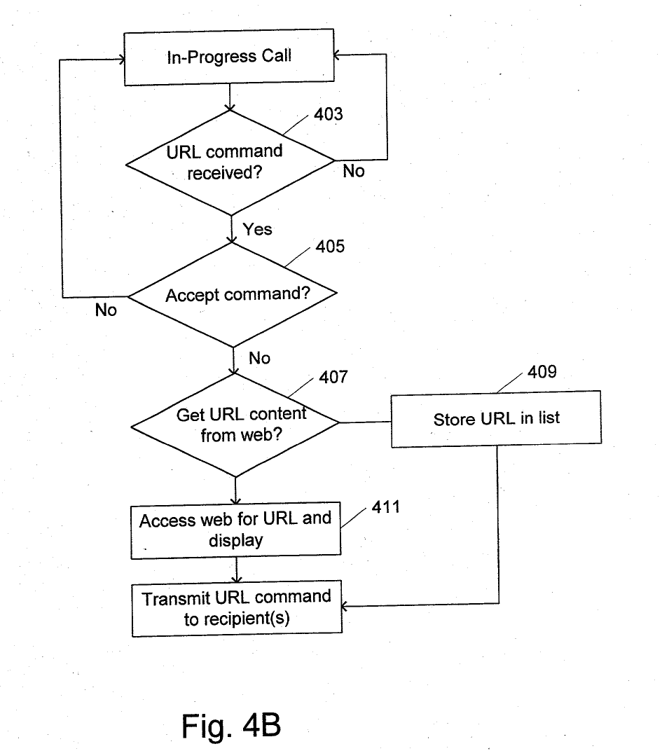

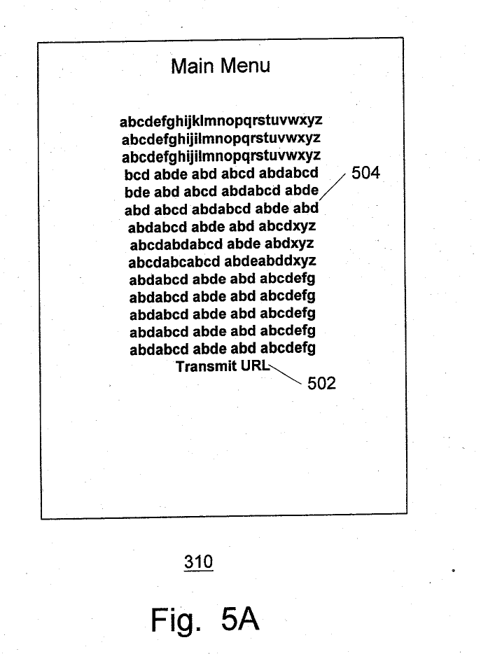

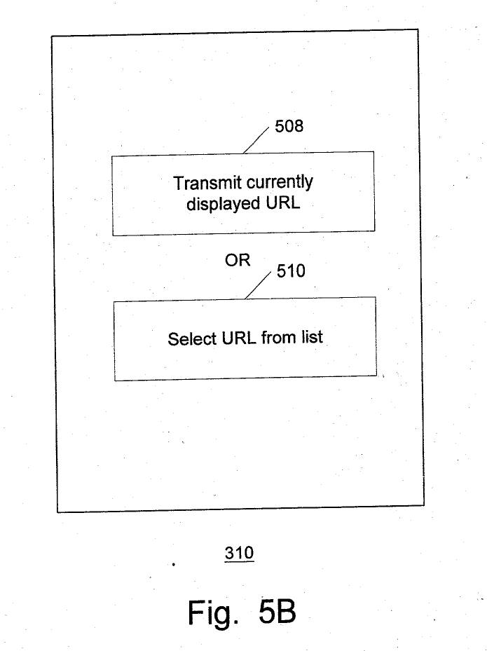

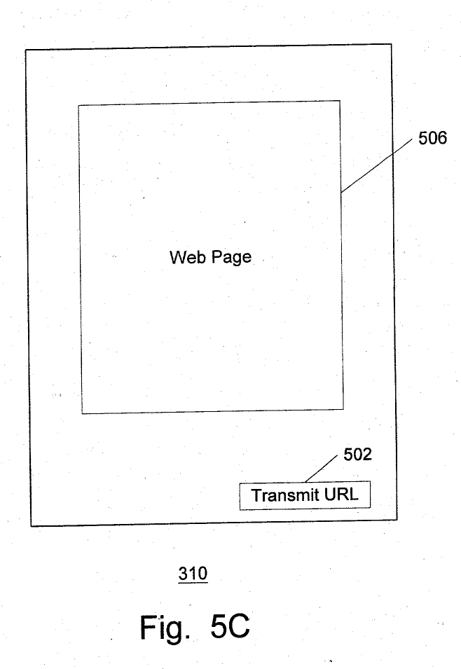

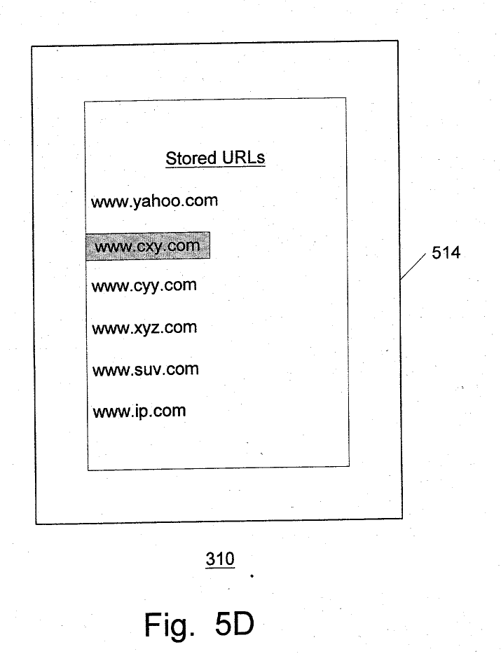

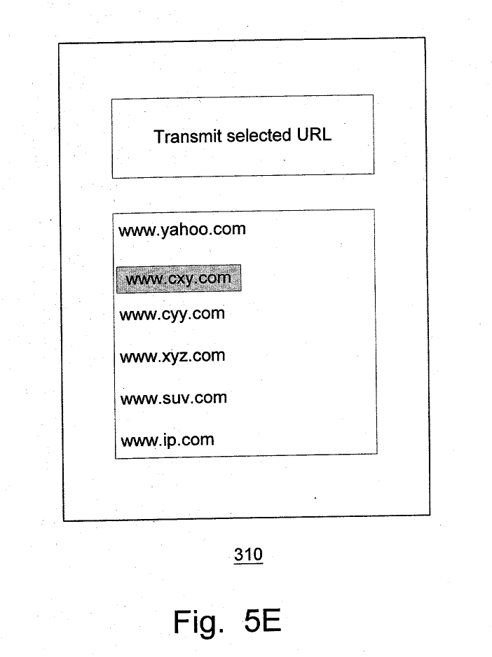

To illustrate the operation of a cellular phone in accordance with the present invention, refer now to the following discussion in conjunction with the accompanying figures. To describe the operation of the system and method in accordance with the present invention, when a call is in progress, from an initiator's perspective as well as the recipient's perspective, refer now to the following description in conjunction with the accompanying figures. FIG. 4A is a flow chart illustrating providing the URL of a web page from the initiator's cellular phone. FIG. 4B is a flow chart which illustrates receiving the URL by a recipient from the initiator. FIGS. 5A-5E are diagrams illustrating the various displays for loading the web page from one cellular phone to another phone. Referring first to the initiator flowchart (FIG. 4A), and also to FIGS. 5A through 5E respectively, first, after the in-progress call is made, a decision must be made to indicate whether a URL is to be transmitted, via step 402 FIG. 5A illustrates the display 310 on the cellular phone. The display 310 includes a plurality of menu items 504 and a transmit URL button 502 for sending of a web page. If the URL is not to be transmitted, then return. If the URL is to be transmitted, then the decision must be made, should the URL of the currently displayed web page be transmitted, via step 404. FIG. 5B illustrates the URL 402 after the transmit is activated. The user may select from a currently displayed URL or a stored URL. If the answer is yes, a URL command corresponding to the displayed URL is transmitted to a recipient, via step 406 (FIG. 5C). Thereafter, the call continues. On the other hand, if the URL is not to be transmitted from the currently displayed web page, then the URL from a stored list is selected, via step 408. FIG. 5D illustrates the display 310 which includes a list 514 of stored URLs. The users may select one of the stored URLs for loading (i.e., www.cxy.com). Thereafter, the URL command is transmitted to the recipient, via step 406 (FIG. 5E).

FIG. 4B illustrates receiving the URL from a recipient viewpoint. First, it is determined if the URL command is received, via step 403. If there is no URL command received, then return. If a URL command is received, it must then be determined if the command is to be accepted, via step 405. If the answer is no, then return. If the answer is yes, it must be determined if the URL content is to be obtained from the Internet, via step 407. If it is not to be accepted from the Internet, then the URL is stored in a list, via step 404, and then the call continues. However, if you are to obtain the content from the web, then the web is accessed via the URL and displayed, via step 411. Thereafter the call continues.

An example of the use of the system and method in accordance with the present invention is described. herein below.

### EXAMPLE

The call initiator is on the phone with a client who needs instructions on how to get to the initiator's place of business. The initiator has a web site that contains a map/directions to his place of business. Both parties' phones are capable of accessing the world wide web. The initiator accesses his stored list of URLs from a phone menu and selects the map/directions URL. The initiator then selects the function that will transmit the URL to the client's phone. The client's phone upon receiving the command accesses the Internet for the URL. The map/directions are now displayed on the client's phone. A similar type of scenario can be laid out for parties needing to discuss data of some sort that is stored on the web or a parent wishing to show a picture of their children stored on the web. With the advent of the third generation of cellular phone networks, web access will be many times faster than now possible, making it possible to load web content quickly.

Accordingly, a system and method in accordance with the present invention makes it possible for one of the parties on the call to cause the other cellular phones to automatically access the desired Internet content without the other party having to manually enter the URL. In so doing, an inefficient and error prone process is eliminated when attempting to access the World Wide Web after a call is established.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for accessing a public network on a party's cellular phone after a call is established between a plurality of parties on a cellular network; the method comprising the steps of:
(a) providing a command over the cellular network from an initiating cellular phone to at least one of the plurality of parties cellular phone that causes the at least one party's cellular phone to access a public network; and
(b) loading content from the public network to the at least one party's cellular phone based upon the command.

2. The method of claim 1 wherein the public network comprises the Internet.

3. The method of claim 2 wherein the command includes the URL related to the content.

4. The method of claim 1 which includes the step of (c) displaying the content.

5. The method of claim 1 wherein the command is sent by selecting from a plurality of stored URLs in the initiating party's cellular phone.

6. The method of claim 1 wherein the command is sent utilizing a URL currently displayed on the initiating party's phone.

7. A cellular phone comprising:
a receiver for receiving a telephone message;
a transmitter for transmitting a telephone message; and
an encoder/decoder for encoding a command onto a transmitted telephone message and for decoding said command from a received telephone message, wherein the encoded command contains the URL of a public network and the decoded command loads content from the public network.

8. The cellular phone of claim 7 wherein the public network comprises the Internet.

9. The cellular phone of claim 8 wherein a command includes the URL related to the content.

10. The cellular phone of claim 9 which includes a display for displaying the content.

11. The cellular phone for claim 10 which also includes:
a storage medium for storing a plurality of URLs; and
a user interface coupled to the storage medium for causing one of the plurality of URLs to be provided with the transmitted telephone message based upon a first action and for causing the URL related to the displayed content to be loaded with the transmitted telephone message based upon a second action.

12. A computer readable medium containing program instructions for accessing a public network on a party's cellular phone after a call is established between a plurality of parties on a cellular network; the program instructions for:
(a) providing a command over the cellular network from an initiating cellular phone to at least one of the plurality of parties cellular phone that causes the at least one party's cellular phone to access a public network; and
(b) loading content from the public network to the at least one party's cellular phone based upon the command.

13. The computer readable medium of claim 12 wherein the public network comprises the Internet.

14. The computer readable medium of claim 13 wherein the command includes the URL related to the content.

15. The computer readable medium of claim 12 which includes the step of (c) displaying the content.

16. The computer readable medium of claim 12 wherein the command is sent by selecting from a plurality of stored URLs in the initiating party's cellular phone.

17. The computer readable medium of claim 1 wherein the command is sent utilizing a URL currently displayed on the initiating party's phone.
